(19) United States
(12) Patent Application Publication
(10) Pub. No.: US 2025/0373748 A1
(43) Pub. Date: Dec. 4, 2025

(54) INFORMATION PROCESSING APPARATUS, CONTROL METHOD, AND STORAGE MEDIUM THAT STORES PROGRAM

(71) Applicant: CANON KABUSHIKI KAISHA, Tokyo (JP)

(72) Inventor: TSUBASA HIRANO, Kanagawa (JP)

(21) Appl. No.: 19/217,947

(22) Filed: May 23, 2025

(30) Foreign Application Priority Data
May 30, 2024 (JP) 2024-088279

(51) Int. Cl. H04N 1/333; H04N 1/327

(52) U.S. Cl. CPC H04N 1/333; H04N 1/32797

(57) ABSTRACT

An information processing apparatus performs control such that, when a setting of a frequency band is changed while the information processing apparatus is operating as an access point, the frequency band is not changed before the information processing apparatus stops operating as the access point, and the information processing apparatus operates based on the changed setting of the frequency band when newly starting operating as the access point after stopping operating as the access point.

### BACKGROUND

### Field of the Technology

The present disclosure relates to an information processing apparatus capable of wireless communication, a control method, and a storage medium that stores a program.

### Description of the Related Art

With an increase in the communication data amount in recent years, development of communication technologies such as wireless local area networks (WLANs) has been advanced. The Institute of Electrical and Electronics Engineers (IEEE) 802.11 standard series is known as major communication standards for WLANs. The IEEE 802.11 standard series includes standards such as IEEE 802.11a/b/g/n/ac/ax. IEEE 802.11n/ac/ax enables 5 GHz and 2.4 GHz frequency bands to be used for WLANs. The communication quality may differ between a plurality of frequency bands. In the 5 GHz band, radio interference is less likely to occur compared to the 2.4 GHz band. The communication speed is normally high when the communication quality is stable, and thus users tend to select the 5 GHz band.

Technologies for connecting a wireless communication apparatus to a WLAN include an infrastructure mode in which a wireless communication apparatus is connected to an access point, and an ad hoc mode in which wireless communication apparatuses are connected peer to peer to each other. Examples of the ad hoc mode include a method that complies with the Wi-Fi Direct® standard (hereinafter, Wi-Fi Direct® will be referred to as WFD) and a method in which a wireless communication apparatus serves as an access point to establish connection (hereinafter, this method will be referred to as an “AP mode”).

Japanese Patent Laid-Open No. 2018-50163 describes, as a technology for a wireless communication apparatus to switch between frequency bands for the AP mode, switching connection to a frequency band in which communication is fast when a print job is received from a wireless terminal while the wireless communication apparatus is operating in a frequency band in which communication is slow.

In Japanese Patent Laid-Open No. 2018-50163, a frequency band for print job control communication to and from a wireless terminal that has submitted the print job is changed. However, if a frequency band is changed, communication between an apparatus operating as an access point and an apparatus connected thereto may be cut off, causing a decrease in the convenience.

### SUMMARY

The present disclosure provides an information processing apparatus that prevents a decrease in user convenience when a frequency band that is used while operating as an access point is changed, a control method, and a storage medium that stores a program.

An aspect of the present disclosure provides an information processing apparatus comprising at least one memory and at least one processor that function to perform wireless communication with a partner apparatus without using an external access point by the information processing apparatus operating as an access point, set a frequency band that is used when the information processing apparatus operates as the access point, and perform control such that, when the setting of the frequency band is changed while the information processing apparatus is operating as the access point, the frequency band is not changed before the information processing apparatus stops operating as the access point, and the information processing apparatus operates based on the changed setting of the frequency band when newly starting operating as the access point after stopping operating as the access point.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a communication system.

FIG. 2 is a diagram illustrating a sequence when STAs are connected to an external AP.

FIG. 3 is a diagram illustrating a hardware configuration of a STA.

FIG. 4 is a diagram illustrating a functional block configuration of the STA.

FIGS. 5A to 5C are diagrams illustrating a setting screen related to an AP mode.

FIG. 6 is a diagram illustrating a setting screen related to the AP mode.

FIGS. 7A and 7B are diagrams illustrating a setting screen related to the AP mode.

FIG. 8 is a diagram illustrating a setting screen related to the AP mode.

FIGS. 9A and 9B are flowcharts illustrating processing when a setting change of a frequency band is accepted.

FIG. 10 is a flowchart illustrating processing when a setting change of a frequency band is accepted.

FIG. 11 is a diagram illustrating a specific example of a communication system.

### DESCRIPTION OF THE EMBODIMENTS

Hereinafter, embodiments will be described in detail with reference to the attached drawings. The following embodiments are not intended to limit the scope of the disclosure. Multiple features are described in the embodiments, but the disclosure does not require all such features, and multiple features may be combined as appropriate. The same reference numerals in the attached drawings are given to the same or similar configurations, and redundant description thereof is omitted.

### First Embodiment

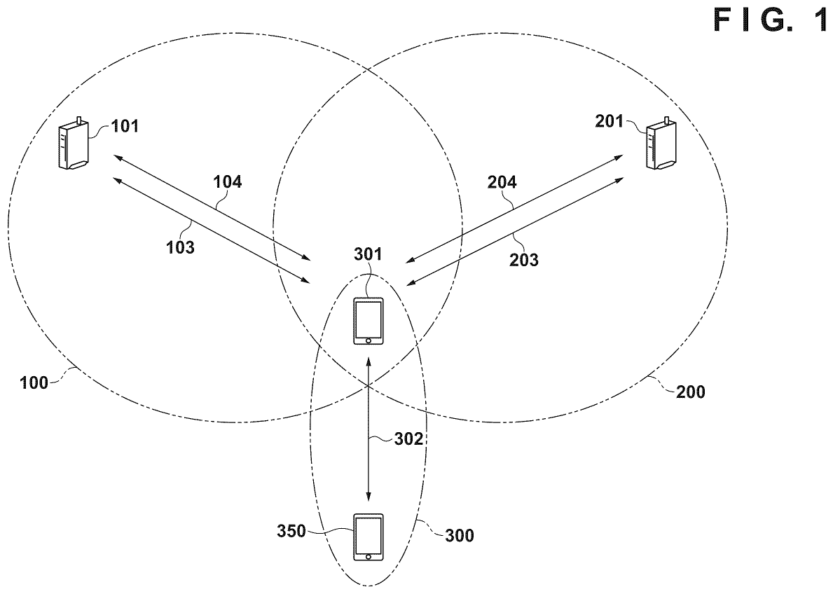

FIG. 1 is a diagram illustrating an exemplary configuration of a communication system of wireless communication apparatuses according to the present embodiment. The configuration of the communication system includes access point AP101, access point AP201 that are wireless communication apparatuses, and an STA 301 and an STA 350 that are wireless communication apparatus.

The wireless communication apparatuses in the communication system illustrated in FIG. 1 can operate in a wireless direct mode and a wireless infra mode. The wireless direct mode is a mode in which wireless communication apparatuses wirelessly communicate with each other directly without an external access point therebetween. Communication in the wireless direct mode may be communication in a software AP mode or a WFD mode, for example. Communication in the wireless direct mode may also be referred to as “wireless direct communication” or “peer-to peer (P2P) communication”.

A wireless communication apparatus that can execute wireless direct communication does not need to support all of these modes, and it suffices for such a wireless communication apparatus to be configured to support only some of the modes. The wireless communication apparatuses can also operate in a wireless infra mode in addition to the wireless direct mode.

For example, a wireless communication apparatus that has a function for performing communication in the WFD mode accepts a user operation via an operation unit of the wireless communication apparatus and calls an application for realizing the communication function. The wireless communication apparatus then executes communication in the WFD mode based on a user operation accepted on a user interface screen provided by the application.

A wireless communication apparatus that operates in the P2P mode operates as a master when connected to and communicating with another apparatus. The WFD mode is not limited thereto, and a wireless communication apparatus may operate as a station by executing group owner negotiation.

In contrast to the wireless direct mode, in the wireless infra mode, wireless communication apparatuses that communicate with each other are connected to an external access point for performing overall management of a network, and communication between the wireless communication apparatuses is performed via the external access point. In other words, communication between the wireless communication apparatuses is executed via a network built by the external access point. In addition, a wireless communication apparatus that operates in the wireless infra mode operates as an STA (station) when connected to/communicating with an external access point. In the wireless infra mode, an external access point is searched for by each communication apparatus transmitting a device search request (probe request). Upon receiving a device search response (probe response) from the external access point, the communication apparatus displays a Service Set Identifier (SSID) included in the probe response. The wireless communication apparatus may be connected to another external access point. In this case, data is transferred between the access points, thereby enabling communication between wireless communication apparatuses.

Commands and parameters transmitted and received during communication between wireless communication apparatuses via an external access point are those specified by the Wi-Fi® standard. In a case of the above configuration, an external access point determines a frequency band and a frequency channel. For example, the external access point selects which frequency band to use, either 5 GHz or 2.4 GHZ, and which frequency channel to use in the selected frequency band.

In FIG. 1, a network 100 is a network formed by the AP 101 that is an access point. In addition, a network 200 is a network formed by the AP 201 that is an access point. The STA 301 that operates as a station can transmit and receive signals to and from the AP 101 and the AP 201. When an access point function of the STA 301 is activated, the STA 301 can operate as an access point to form a network 300, and perform P2P communication with the STA 350.

The STA 301 can join the networks formed by the AP 101 and the AP 201, and the AP 101, the AP 201, and the STA 301 can execute wireless communication that complies with the IEEE 802.11n/ac/ax standards. The communication apparatuses can perform communication in frequency bands of 2.4 GHZ, 5 GHZ, and 6 GHZ, for example. Frequency bands that are used by the communication apparatuses are not limited thereto, and for example, another frequency band such as a 60 GHz band may be used. The APs 101 and 201 and the STAs 301 and 350 can perform communication using frequency bands of 20 GHz, 40 MHz, 80 MHz, 160 MHz, and 320 MHz. Bandwidths that are used by the communication apparatuses are not limited thereto, and for example, other bandwidths of 240 MHz, 4 MHZ, and the like may also be used.

The foregoing describes the APs 101 and 201 and the STAs 301 and 350 executing wireless communication that complies with the IEEE 802.11n/ac/ax standards. In addition to this, the APs 101 and 201 and the STAs 301 and 350 may also execute wireless communication complying with the legacy standard that is earlier than the IEEE 802.11n/ac/ax standards. Specifically, for example, the APs 101 and 201 and the STAs 301 and 350 may execute wireless communication complying with at least one of the IEEE 802.11a/b/g/n/ac/ax standards. The APs 101 and 201 and the STAs 301 and 350 may execute wireless communication complying with other communication standards such as Bluetooth®, Near-field Communication (NFC), Ultra Wide Band (UWB), ZigBee, and Multi-Band OFDM Alliance (MBOA) in addition to the IEEE 802.11 series standards. UWB includes a wireless USB, wireless 1394, WiNET, and the like. The APs 101 and 201 and the STAs 301 and 350 may execute communication complying with a communication standard of wired communication of a WLAN or the like. Specific examples of the AP 101 and the AP 201 include a WLAN router, a personal computer (PC), and the like, but there is no limitation thereto. The AP 101 may also be an information processing apparatus such as a radio chip that can execute wireless communication that complies with the IEEE 802.11n/ac/ax standards. Specific examples of the STA 301 and the STA 350 include a printer, a multi-function peripheral, a camera, a tablet, a smartphone, a PC, a mobile phone, a video camera, a headset, and the like, and there is no limitation thereto. The STA 301 and the STA 350 may also be information processing apparatuses such as radio chips that can execute wireless communication complying with the IEEE 802.11n/ac/ax standards.

The APs 101 and 201 and the STAs 301 and 350 select one of a plurality of frequency bands, establish connection, and execute communication. For example, the AP 101 has a link 103 of a first frequency band that is the 5 GHz band and a link 104 of a second frequency band that is the 2.4 GHz band. For example, the AP 201 has a link 203 of the first frequency band that is the 5 GHz band and a link 204 of the second frequency band that is the 2.4 GHz band. The STA 301 establishes connection using information such as an SSID allocated to a link of each of the APs. The AP 101 and the AP 201 can set the same SSID for links of frequency bands, the STA 301 can identify each link based on a frequency band and a BSSID (MAC address) included in a packet transmitted from an AP.

The STA 301 can establish a link of the wireless direct mode for P2P connection with a wireless communication apparatus. The STA 301 can switch a frequency band that is used for the wireless direct mode between the 5 GHz band and the 2.4 GHz band. The STA 301 is an example of a wireless communication apparatus that can operate in the wireless direct mode, and can also operate in the wireless infra mode.

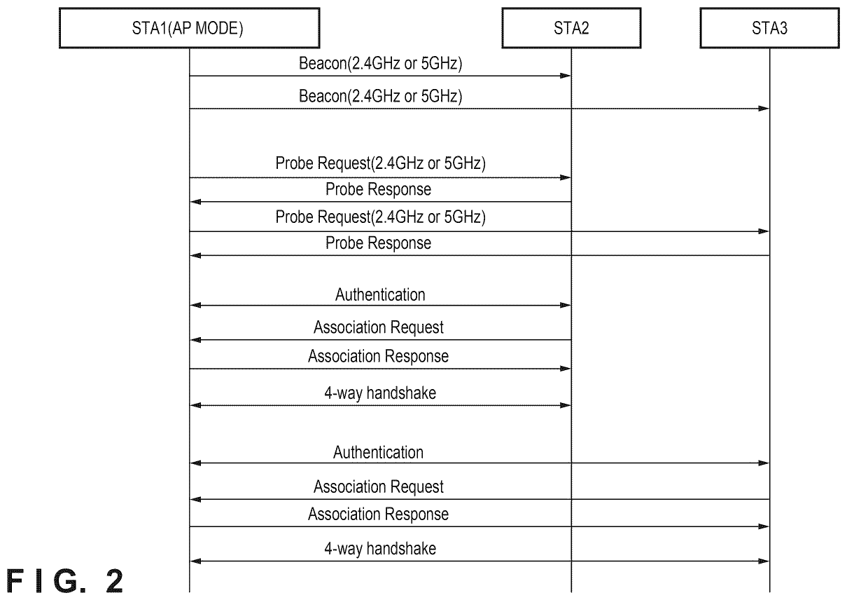

FIG. 2 is a diagram illustrating an example of a sequence when an STA establishes a link to an external AP, in other words, an STA is connected to an external AP (an STA that has started an AP mode). STA1 starts an access point mode (hereinafter, an “AP mode”), and transmits a beacon. STA2 and STA3 can recognize the presence of STA1 that has started the AP mode. STA2 and STA3 transmit a probe request to STA1 and receive a probe response from STA1, and thereby determine that link establishment can be started. STA1, STA2, and STA3 establish a link by performing authentication communication. Authentication communication includes steps of authentication, association request, association response, and 4-way handshake. When the wireless communication apparatus STA1 operating in the wireless infra mode is connected to an external access point, a link is established in the same sequence similarly, but with STA1 in FIG. 2 replaced with the external access point, and STA2 and STA3 in FIG. 2 replaced with STA1 operating in the wireless infra mode.

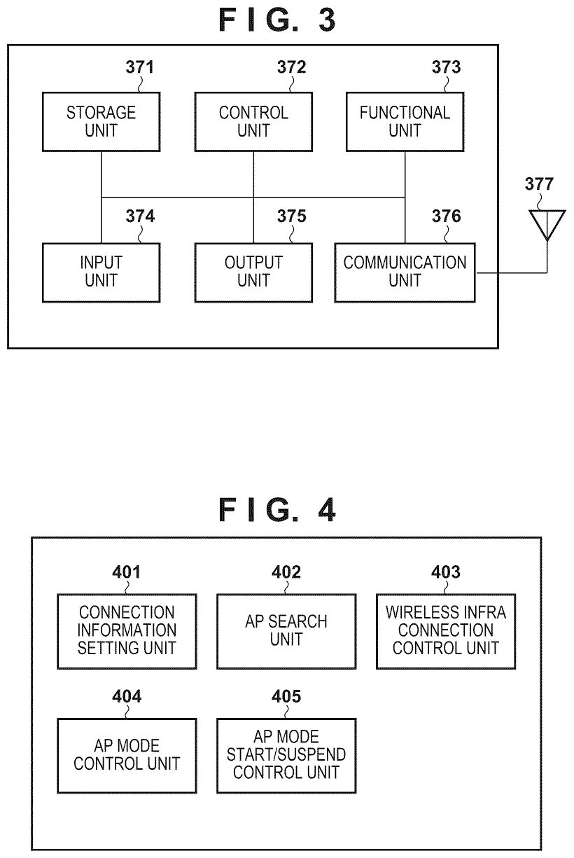

FIG. 3 is a diagram illustrating an exemplary hardware configuration of the STA 301. The STA 301 includes a storage unit 371, a control unit 372, a functional unit 373, an input unit 374, an output unit 375, a communication unit 376, and an antenna 377. There may be a plurality of antennas.

The storage unit 371 is constituted by one or more memories such as a Read Only Memory (ROM) and a Random Access Memory (RAM), and stores computer programs for performing various operations described below, and various types of information such as communication parameters for wireless communication. As the storage unit 371, memories other than the ROM and the RAM, a storage medium such as a flexible disk, a hard disk, an optical disk, a magneto-optical disk, a CD-ROM, a CD-R, a magnetic tape, a non-volatile memory card, or a DVD may also be used. The storage unit 371 may include a plurality of memories, and the like.

The control unit 372 is constituted by one or more processors such as a central processing unit (CPU) and a micro processing unit (MPU), for example, and performs overall control of the STA 301 by executing computer programs stored in the storage unit 371. For example, operations of the STA 301 according to the present embodiment are realized by the CPU of the control unit 372 executing programs. The control unit 372 may perform overall control of the STA 301 in cooperation with an operating system (OS) and computer programs stored in the storage unit 371. The control unit 372 generates data and signals (wireless frames) transmitted in communication with another wireless communication apparatus. A configuration may be adopted in which the control unit 372 includes a plurality of processors, such as a multi-core processor, and the processors perform overall control of the STA 301. The control unit 372 controls the functional unit 373 to execute wireless communication and other processing. The other processing is processing corresponding to a function that can be executed by a device configured as STA1, and is processing such as imaging, printing, and projection if STA1 is configured as an MFP. The functional unit 373 is hardware for executing processing corresponding to a function that can be executed by a device configured as the STA 301.

The input unit 374 accepts various operations from a user. The output unit 375 performs various types of output to the user via a display screen or a speaker. Output performed by the output unit 375 may be display on the display screen, sound output via the speaker, vibrational output, or the like. Both the input unit 374 and the output unit 375 may be realized as a single module, such as a touch panel. The input unit 374 and the output unit 375 may be integrated with or separate from the STA 301. Hereinafter, the input unit 374 and the output unit 375 will be collectively referred to as a user interface (UI) unit.

The communication unit 376 controls wireless communication that complies with the IEEE 802.11 series standards. The communication unit 376 controls the antenna 377 to transmit and receive data for wireless communication generated by the control unit 372. If the STA 301 complies with the NFC standard, the Bluetooth® standard, and the like in addition to the IEEE 802.11 series standards, wireless communication complying with these communication standards may be performed. In addition, if the STA 301 can execute wireless communication complying with a plurality of communication standards, the STA 301 may be configured to include communication units and antennas corresponding to the respective communication standards. The STA 301 transmits and receives data such as image data, document data, and video data to and from the STA 350 via the communication unit 376, for example. The antenna 377 may be configured separately from the communication unit 376, or may be configured as one module integrated with the communication unit 376. The antenna 377 is an antenna that communicates in the 2.4 GHz band and the 5 GHz band. In the present embodiment, the STA 301 includes one antenna as an example.

The AP 101, the AP 201, and the STA 350 each have a hardware configuration similar to the STA 301 in FIG. 3. In addition, the AP 101 and the AP 201 may have a different configuration from the STA 301. For example, the STA 301 includes one antenna 377, but the AP 101 and the AP 201 may include different antennas for respective frequency bands. In addition, if the AP 101 and the AP 201 include a plurality of antennas, the AP 101 and the AP 201 may include communication units 376 respectively corresponding to the respective antennas.

A specific exemplary configuration of STA 301/STA 350 in FIG. 1 will now be described.

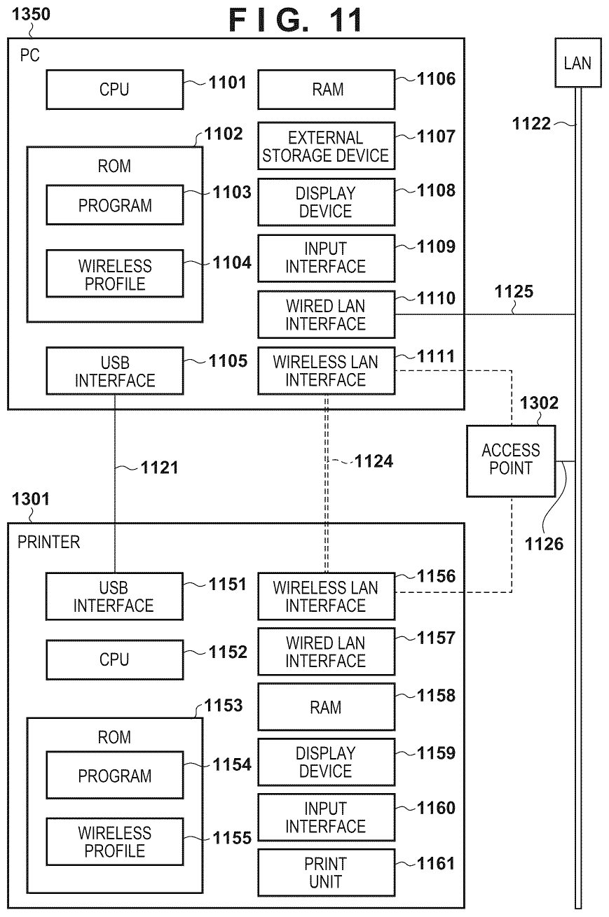

FIG. 11 is a diagram illustrating a hardware configuration of a communication system that includes a PC 1350 and a printer 1301 according to the present embodiment. The PC 1350 corresponds to the STA 350 in FIG. 1, and the printer 1301 corresponds to the STA 301 in FIG. 1. An access point 1302 corresponds to the AP 101 or the AP 201 in FIG. 1.

The PC 1350 includes a CPU 1101, a ROM 1102, a RAM 1106, an external storage device 1107, a display device 1108, and an input interface 1109. The element of the PC 1350 that executes programs is formed by the CPU 1101, the ROM 1102, the RAM 1106, and the like. The PC 1350 includes a universal serial bus (USB) interface 1105, a wired LAN interface 1110, and a WLAN interface 1111. A configuration of the PC 1350 is not limited to the configuration illustrated in FIG. 11, and the PC 1350 includes functional blocks that can be executed by a device applied as the PC 1350, as appropriate.

The CPU 1101 is a processor that reads out and executes a control program stored in the ROM 1102, and performs overall control of the PC 1350 using the control program. As a result of the control program being executed, various functions of the PC 1350 such as control of communication with an external device such as the printer 1301, generation of print jobs to be output to the printer 1301, and instructions on network setup are realized. The RAM 1106 is constituted by a DRAM, an SRAM, or the like that requires a backup power source, and is used as a memory area for storing temporary setting information, management data, and the like when the PC 1350 operates. The RAM 1106 is also used as a temporary storage region such as a main memory, a work area, and the like of the CPU 1101, and as a transmission buffer for temporarily storing print jobs generated to be transmitted to the printer 1301, or the like.

The ROM 1102 stores a program 1103 corresponding to various types of processing including a program for network setup processing for transmitting setting information of an external AP to a printer, a wireless profile 1104, and the like. The external storage device 1107 stores an operating system (OS), a printer driver, and other various types of data. The display device 1108 is constituted by a light-emitting diode (LED) display, a liquid crystal display (LCD), or the like, and displays various user interface screens of the OS and the program 1103 and performs notification of the status of the PC 1350. The input interface 1109 is an interface for accepting data input and user instruction operations from a user by an operation being performed on an operation unit such as a keyboard. The operation unit may be a physical keyboard, physical buttons, and the like, or may be a soft keyboard, soft buttons, and the like that are displayed on the display device 1108. The input interface 1109 may accept input from a user via the display device 1108.

The program for network setup processing is an application program for performing setting for connecting to an AP for connecting the printer 1301, and may also include functions other than the network setup function. The program for network setup processing is also called a setup application. The setup application may have a function for causing the printer 1301 to execute printing, a function for causing the printer 1301 to scan a document set thereon, and a function for checking the status of the printer 1301, for example. The setup application may also have a function for transmitting information obtained from the printer 1301, user's personal information obtained by the PC 1350, and the like to a service management server (not illustrated). The setup application is stored in the ROM 1102, by, for example, being installed from an external server via Internet communication that is performed via the WLAN interface 1111. The setup application is an application program provided by a vendor of the printer 1301.

The ROM 1102 stores network information. The network information includes IP addresses allocated to the WLAN interface 1111 and the wired LAN interface 1110 of the PC 1350, and the IP address and subnet mask of the AP to which the PC 1350 is connected. In addition, wireless profiles of APs to which the PC 1350 has been connected are stored as the network information. In other words, the ROM 1102 stores the history information of APs to which the PC 1350 was previously connected. The wireless profile information includes the SSIDs, security settings, and passwords of the APs to which the PC 1350 has been connected.

The wired LAN interface 1110 and the WLAN interface 1111 are configurations for connecting to external apparatuses such as the printer 1301 and an AP 1302, and executing data communication. For example, the WLAN interface 1111 is connectable to an access point (not illustrated) within the printer 1301. The WLAN interface 1111 controls transmission and receiving of data that complies with a communication standard defined in IEEE 802.11 based on an instruction from the CPU 1101. A wireless communication method that is used at this time is, for example, a method defined as Wi-Fi® by the industry organization Wi-Fi® Alliance, and is defined as a WLAN standard. In addition, as an access point within the PC 1350, the WLAN interface 1111 includes an access point for connection to an apparatus such as the printer 1301. This access point is generally referred to as tethering. A wireless LAN interface 1156 of the printer 1301 can be connected to the access point. By the WLAN interface 1111 activating the access point, the PC 1350 operates as an access point. By the WLAN interface 1156 and the access point within the WLAN interface 1111 being connected to each other, the PC 1350 and the printer 1301 can communicate with each other. When the WLAN interface 1111 of the PC 1350 is connected to the Internet, the printer 1301 can also be connected to the Internet via the WLAN interface 1111.

The PC 1350 can be P2P-connected (directly connected) to the printer 1301 via a USB cable 1121, or by wireless direct connection 1124 using the WLAN interface 1111. The PC 1350 can also be connected to a LAN 1122 via an Ethernet cable 1125, and if the printer 1301 can also be connected to the LAN 1122, the PC 1350 and the printer 1301 can communicate with each other in the same environment of the LAN 1122. By the PC 1350 being connected to the AP 1302 via the WLAN interface 1111, and the AP 1302 being connected to the LAN 1122 via an Ethernet cable 1126, the PC 1350 can be connected to the LAN 1122. If the printer 1301 can also be connected to the AP 1302, the PC 1350 and the printer 1301 can communicate with each other via the AP 1302.

The printer 1301 includes a CPU 1152, a ROM 1153, a RAM 1158, a display device 1159, an input interface 1160, a USB interface 1151, the WLAN interface 1156, and a wired LAN interface 1157. The element of the printer 1301 that executes programs is formed by the CPU 1152, the ROM 1153, the RAM 1158, and the like. A configuration of the printer 1301 is not limited to the configuration illustrated in FIG. 11, and the printer 1301 includes functional blocks that can be executed by a device applied as the printer 1301 (e.g., a multi-function peripheral (MFP)), as appropriate.

The CPU 1152 is a processor that reads out and executes a control program stored in the ROM 1153, performs overall control of the printer 1301 using the control program, and executes processing illustrated in the flowchart described below. As a result of the control program being executed, various functions of the printer 1301 including control of communication with an external apparatus such as the PC 1350 are realized. The RAM 1158 is constituted by a DRAM, an SRAM, or the like that requires a backup power source, and is used as a memory area for storing temporary setting information, management data, and the like when the printer 1301 operates. The RAM 1158 may also be used as a temporary storage region such as a main memory, a work area, and the like of the CPU 1152, and operate as a receiving buffer for temporarily holding print information received from the PC 1350 or the like.

The ROM 1153 is a non-volatile flash memory that stores control programs that are executed by the CPU 1152, data tables, and fixed data of an embedded OS or the like. In the present embodiment, the control programs stored in the ROM 1153 perform software execution control such as scheduling, task switching, and interrupt processing under the management of the embedded OS stored in the ROM 1153.

The ROM 1153 stores a program 1154, a wireless profile 1155, and the like. The wireless profile 1155 is information that includes SSIDs, authentication information (passwords, etc.), and the like of APs to which the WLAN interface 1156 was connected. The wireless profile 1155 is stored and managed by the CPU 1152 executing the program 1154 included in the ROM 1153. For example, when the printer 1301 is turned on, the printer 1301 can be connected to a previous network again by using the wireless profile 1155. For example, the printer 1301 may be configured to manage a plurality of wireless profiles as with the OS of the PC 1350.

The ROM 1153 also stores a unique SSID that is set in the printer 1301. Here, the unique SSID is defined for the manufacturer of the printer or the printer model, and the WLAN interface 1156 of the printer 1301 can operate as an AP corresponding to this unique SSID. For this reason, the PC 1350 can be connected to the printer 1301 that operates as the AP corresponding to the unique SSID by the wireless direct connection 1124, similarly to a case of being connected to the AP 1302.

The display device 1159 is constituted by a light-emitting diode (LED) display, a liquid crystal display (LCD), or the like, and displays various menus, and performs notification of the status of the printer 1301. The input interface 1160 is an interface for accepting data input and user instruction operations from a user by an operation being performed on an operation unit such as a keyboard. The operation unit may be a physical keyboard, physical buttons, and the like, or may be a soft keyboard, soft buttons, and the like that are displayed on the display device 1159. That is, the input interface 1160 may accept input from the user via the display device 1159.

The print unit 1161 forms an image on a printing medium, such as cut paper, by ejecting a printing agent, such as ink, to the printing medium based on image data, and outputs a print result. The print unit 1161 is configured to perform initial setup processing that includes printhead cleaning and registration adjustment for adjusting an ink ejection position, if it is determined that the power-on is a power-on performed upon arrival. The print unit 1161 may have a configuration in which the inkjet printing method and other printing methods, such as the electrophotographic method, is adopted.

The printer 1301 can perform P2P communication with the PC 1350 via the USB cable 1121 or by the wireless direct connection 1124. By the printer 1301 being connected to the AP 1302 via the WLAN interface 1156, and the AP 1302 being connected to the LAN 1122 via the Ethernet cable 1126, the printer 1301 can be connected to the LAN 1122. In the description of FIG. 11, as an example, processing is shared between the PC 1350 and the printer 1301 in the above description, but a configuration may be adopted in which the processing is shared in another manner.

Modes and connection methods for executing wireless communication using a WLAN interface will be described below.

### Direct Connection Method

Direct connection refers to a form in which apparatuses are wirelessly connected to each other directly without an external apparatus such as the AP 1302. The printer 1301 can operate in a mode for performing communication by direct connection (direct connection mode), as a connection mode. As described above, there are a plurality of modes for performing Wi-Fi® communication by direct connection, including the software AP mode and the WFD mode.

A mode for executing direct connection by WFD is called a “WFD mode”. WFD is a standard formulated by the Wi-Fi® Alliance, and included in the communication standards of the IEEE 802.11 series. In the WFD mode, after a device that is to be a communication partner is searched for by a device search command, roles of a P2P GO (group owner) and a P2P client are determined, and remaining wireless connection processing is then performed. The group owner corresponds to a Wi-Fi® master station (master), while the client corresponds to a Wi-Fi® slave station (station). This role assignment is called GO negotiation. In the WFD mode in a state before role assignment is performed, the printer 1301 is not a master station or a slave station. Specifically, first, one of two devices that communicate with each other issues a device search command, and searches for a device to which the one device is to be connected in the WFD mode. When the other device that is to be a communication partner is discovered, the two devices confirm information regarding services and functions that can be supplied between the devices. This device supply information confirmation is optional and not necessary. The phase of this device supply information confirmation corresponds to P2P provision discovery, for example. By the devices confirming this device supply information, it is determined which device will be a P2P client and which will be a P2P group owner. When the client and the group owner are determined, the client and the group owner exchange parameters for performing communication by WFD. Based on the exchanged parameters, the client and the group owner perform remaining wireless connection processing and IP connection processing. In the WFD mode, the printer 1301 may always operate as a GO without executing the above GO negotiation. That is, the printer 1301 may operate in a WFD mode that is an autonomous GO mode. In addition, a state where the printer 1301 is operating in the WFD mode is, for example, a state where WFD connection has not been established but the printer 1301 is operating as a GO, or a state where WFD connection has been established and the printer 1301 is operating as a GO.

In the software AP mode, from among devices that communicate with each other (e.g., the PC 1350 and the printer 1301), one device (e.g., the PC 1350) serves as a client, which take on the role of requesting various services. The other device realizes functions of an access point in Wi-Fi® through software settings. Determination of these roles does not involve negotiation for determining which device is to operate as an AP as with the WFD mode, and an apparatus that operates in the software AP mode operates as an AP. A software AP corresponds to a Wi-Fi® master station, while a client corresponds to a Wi-Fi® slave station. In the software AP mode, the client searches for a device that is to be a software AP by a device search command. When a software AP is discovered, the client and the software AP perform remaining wireless connection processing (establishment of wireless connection, etc.), and then perform IP connection processing (allocation of IP addresses, etc.). Commands and parameters defined in the Wi-Fi® standard may be used as commands and parameters transmitted and received when realizing wireless connection between a client and a software AP, and a description thereof is omitted herein.

In the present embodiment, when the printer 1301 has established and is maintaining direct connection, the printer 1301 operates as a master station in the network to which the printer 1301 belongs. The master station is an apparatus that builds a wireless network, and provides parameters used for connection to the wireless network to a slave station. The parameters used for connection to the wireless network are, for example, parameters related to a channel used by the master station. By receiving the parameters, the slave station uses the channel used by the master station to be connected to the wireless network built by the master station. In the direct connection mode, the printer 1301 operates as a master station, and thus the printer 1301 can determine which frequency band and which channel to use for communication in the direct connection mode. In the present embodiment, the printer 1301 can use channels corresponding to the 2.4 GHz frequency band and the 5 GHz frequency band to perform communication in the direct connection mode.

### Infrastructure (Infra) Connection Method

Infra connection is a connection form for connecting devices (e.g., the PC 1350 and the printer 1301) that communicate with each other to an access point (e.g., the AP 1302) that performs overall management of a network, and thereby enabling the devices to communicate with each other via the access point. The printer 1301 can also operate in a mode for communication by infra connection (infra connection mode), as a connection mode.

In infra connection, each device searches for an access point in based on a device search command. When an access point is discovered, the device and the access point perform remaining wireless connection processing (establishment of wireless connection, etc.), and then perform IP connection processing (allocation of IP addresses, etc.). Commands and parameters defined in the Wi-Fi® standard may be used as commands and parameters transmitted and received when realizing wireless connection between the device and the access point, and thus, a description thereof is omitted herein.

In the present embodiment, when the printer 1301 operates by infra connection, the AP 1302 operates as a master station and the printer 1301 operates as a slave station. That is, in the present embodiment, infra connection refers to connection between the printer 1301 that operates as a slave station and the AP 1302 that operates as a master station. In a case where the printer 1301 has established infra connection, and the PC 1350 also has established infra connection with the AP 1302, communication can be performed between the printer 1301 and the PC 1350 via the AP 1302. A channel that is used for communication by infra connection is determined by the AP 1302, and thus the printer 1301 executes communication by infra connection using the channel determined by the AP 1302. In the present embodiment, the printer 1301 can use a channel corresponding to the 2.4 GHz frequency band and a channel corresponding to the 5 GHz frequency band to perform communication by infra connection. The printer 1301 can also use a channel corresponding to dynamic frequency selection (DFS) in the 5 GHz frequency band to perform communication by infra connection. In order to communicate with the printer 1301 via the AP 1302, the PC 1350 needs to recognize (search for and discover) that the printer 1301 belongs to a network that is formed by the AP 1302, and to which the PC 1350 belongs.

### Network Setup Mode

The printer 1301 can operate in the network setup mode. A trigger for the printer 1301 to start operating in the network setup mode may be, for example, the user selecting a network setup mode button, or may be the printer 1301 being started (turned on) for the first time after arrival. The network setup mode button may be a hard (physical) button included in the printer 1301, or may be a software button displayed on the display device 1159 by the printer 1301.

When starting operating in the network setup mode, the printer 1301 activates Wi-Fi® communication. Specifically, as Wi-Fi® communication activation processing, the printer 1301 activates the internal AP (setup AP) thereof dedicated to the network setup mode. The SSID of the setup AP corresponds to the above unique SSID. Thus, the printer 1301 is ready to establish direct Wi-Fi® connection to the PC 1350. Assume that connection information (an SSID and a password) for connection to the setup AP was stored, in advance, and used in a setup application (the program 1103) installed in the PC 1350, and the PC 1350 recognized the connection information for connection to the setup AP in advance. For this reason, unlike connection information of an AP that is activated in the direct connection mode, the connection information for connection to the setup AP cannot be arbitrarily changed by a user. In the network setup mode, the printer 1301 may be connected to the PC 1350 by WFD instead of standard Wi-Fi®. That is, the printer 1301 may operate as a group owner and receive network information from the PC 1350 via WFD communication. In the network setup mode, the printer 1301 may be connected to the PC 1350 by Bluetooth®. Here, Bluetooth® includes Bluetooth® Classic and Bluetooth® low energy (BLE). Specifically, for example, in the network setup mode, the printer 1301 may operate as a slave apparatus in BLE, and receive network information from the PC 1350 through BLE communication. In addition, in the network setup mode, the printer 1301 may be able to execute both Wi-Fi® network setup and BLE network setup. That is, when starting operating in the network setup mode, the printer 1301 may activate both Wi-Fi® communication and BLE communication. Specifically, when starting operating in the network setup mode, the printer 1301 may execute both activation of the setup AP and activation of an advertising state that is a state where BLE connection is enabled by transmitting advertisement information by BLE. In addition, the printer 1301 may receive network information from the PC 1350 using a wired LAN or a USB.

As described above, the printer 1301 operates in the network setup mode for executing network setup of the printer 1301 under a predetermined condition that includes the user selecting a button or initial installation. When operating in the network setup mode, the printer 1301 controls the WLAN interface 1156, and operates as a setup AP that is enabled only when the printer 1301 is operating in the network setup mode. The setup AP is an access point different from the access point that is activated in the above software AP mode. The SSID of the setup AP includes predetermined character strings that can be recognized by the setup application (the program 1103) of the PC 1350.

The printer 1301 operating in the network setup mode uses a predetermined communication protocol (setup communication protocol) in communication with the PC 1350 connected to the setup AP. Specifically, the setup communication protocol is, for example, simple network management protocol (SNMP).

When a predetermined time has elapsed after the printer 1301 started operating in the network setup mode, the printer 1301 stops operating in the network setup mode, and inactivates the setup AP. When connection information for connection to an external AP and an instruction to change the operation mode of wireless communication are received from the PC 1350 while the printer 1301 is in the network setup mode, the setup AP is inactivated.

FIG. 4 is a diagram illustrating an example of a functional block configuration of the STA 301. The functional blocks in FIG. 4 are realized by the CPU of the control unit 372 executing programs, or operating in cooperation with hardware within the STA 301, for example. The STA 350 has a configuration similar to that in FIG. 4. Hereinafter, the direct connection mode will be referred to as an “AP mode”. This is not limited to the above software AP mode, and represents direct connection mode for communication by direct connection.

The STA 301 includes a connection information setting unit 401, an AP search unit 402, a wireless infra connection control unit 403, an AP mode control unit 404, and an AP mode start/suspend control unit 405. The connection information setting unit 401 controls setting of connection information for connection to the AP 101 and the AP 201, the connection information having been input via the UI unit. Specifically, for example, input of information required for connection such as an SSID and a password is accepted from the UI unit, and the information is stored in the storage unit 371. The AP search unit 402 receives a beacon from an AP near the STA 301 and thereby discovers the external AP. The AP search unit 402 provides an SSID list of discovered APs to the connection information setting unit 401. The connection information setting unit 401 displays the SSID list on the UI unit, accepts a selected SSID and information required for connection such as a password, from the user via the UI unit, and stores them in the storage unit 371.

The wireless infra connection control unit 403 receives, from the connection information setting unit 401, connection information for connection to the AP 101 and the AP 201, and controls processing for establishing a link. Specifically, link establishment is performed, for example, by probes, authentication, association, and 4-way handshake (4WHS) in FIG. 2. The wireless infra connection control unit 403 transmits a probe request using the frequency bands of 2.4 GHz and 5 GHz.

The AP mode control unit 404 controls processing in which the STA 301 serves as an access point, transmits a beacon, and accepts a probe request and a connection request from another STA. The frequency band of 5 GHz or 2.4 GHz can be set as a frequency band that is used, using the UI unit, and communication is performed in the set frequency band. The AP mode control unit 404 can establish a link to a plurality of STAs.

The AP mode start/suspend control unit 405 instructs the AP mode control unit 404 to start or suspend the AP mode. The AP mode start/suspend control unit 405 controls switching timings of the frequency band that is used for the AP mode. As described below, instead of performing switching (reflecting the setting content on operations) as soon as a change in the AP mode frequency setting is accepted via the UI unit, the AP mode start/suspend control unit 405 determines a switching condition, and based on the determination result, instructs the AP mode control unit 404 to start or suspend the AP mode.

The wireless infra connection control unit 403 and the AP mode control unit 404 can operate simultaneously. When the wireless infra connection control unit 403 and the AP mode control unit 404 are performing simultaneous operations using the same frequency band, the AP mode control unit 404 monitors the channel that the wireless infra connection control unit 403 is using in order not to use the same channel as a channel in use for wireless infra connection. When the same channel is used as the channel in use for wireless infra connection, the channel is switched to a different channel. When the status of wireless infra connection changes from “disconnected” to “connected”, the AP mode start/suspend control unit 405 confirms whether the same frequency is being used for wireless infra connection. When the same frequency is being used, and the AP mode is active, the AP mode start/suspend control unit 405 temporarily suspends the AP mode, and starts the AP mode after a channel for wireless infra connection is determined.

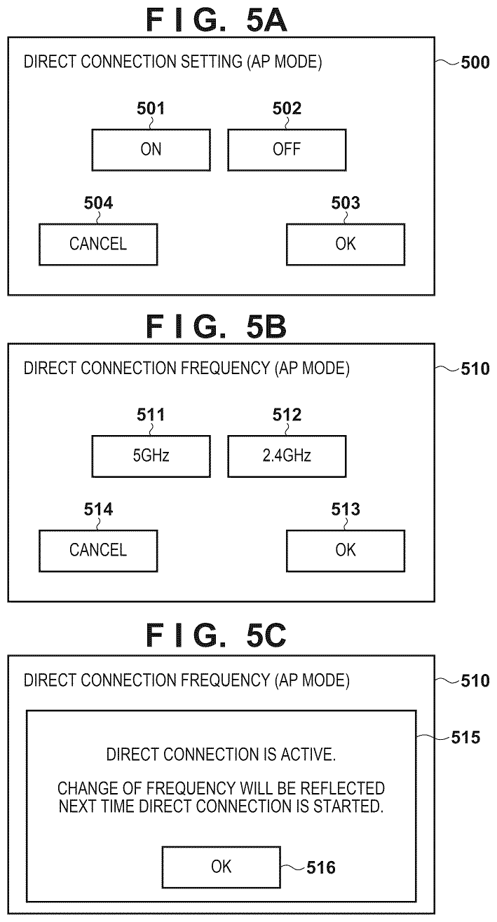

FIGS. 5A to 7B are diagrams illustrating an example of a setting screen related to the AP mode according to the present embodiment. The screens in FIGS. 5A to 7B are displayed, for example, by setting items related to the AP mode being selected from a menu screen displayed on the UI unit.

An AP mode setting screen 500 in FIG. 5A is a screen for performing setting for activating/inactivating the AP mode in the STA 301. A user can select a button 501 for setting the AP mode to “ON” or a button 502 for setting the AP mode to “OFF” on the AP mode setting screen 500. An OK button 503 is a button for submitting the setting content determined using the button 501 or 502. The submitted setting content is stored in the storage unit 371. When a cancel button 504 is selected, display of the AP mode setting screen 500 ends without submitting the setting content for activating/inactivating the AP mode. For example, if a user changes the setting from “ON” (the button 501) to “OFF” (the button 502) and selects the OK button 503 while the AP mode is active, the setting content on the AP mode setting screen 500 is submitted, and the AP mode is then suspended. A timing for suspending the AP mode will be described below.

An AP mode frequency setting screen 510 in FIG. 5B is a screen for setting a frequency band that is used when the AP mode is started in the STA 301. A user can select a button 511 for setting a frequency band that is used for the AP mode to the 5 GHz band or a button 512 for setting the frequency to the 2.4 GHz band on the AP mode frequency setting screen 510. An OK button 513 is a button for submitting the setting content determined using the button 511 or 512. The submitted setting content is stored in the storage unit 371. When a cancel button 514 is selected, display of the AP mode frequency setting screen 510 ends without submitting the setting content of the frequency band. The AP mode start/suspend control unit 405 can detect that the setting has been changed on the AP mode frequency setting screen 510. For example, if a user changes the frequency band that is used for the AP mode and selects an OK button 514 while the AP mode is active, the AP mode start/suspend control unit 405 displays a popup message 515 in FIG. 5C. The popup message 515 notifies a user that the setting change of the frequency band will be reflected on operations the next time the AP mode is started. When an OK button 516 is selected, display of the popup message 515 ends, and the screen returns to the AP mode frequency setting screen 510 in FIG. 5B.

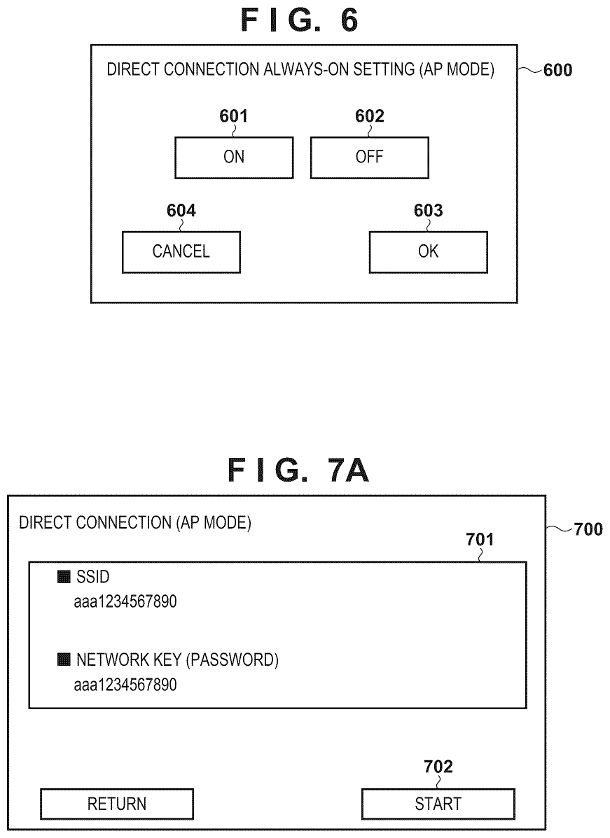

An AP mode always-on setting screen 600 in FIG. 6 is a screen for setting whether to always activate the AP mode in the STA 301. In other words, the AP mode always-on setting screen 600 is a screen for activating or de-activating the AP mode always-on setting. The user can select a button 601 for setting the AP mode always-on setting to “ON” or a button 602 for setting the AP mode always-on setting to “OFF” on the AP mode always-on setting screen 600. An OK button 603 is a button for submitting the setting content determined using the button 601 or 602. The submitted setting content is stored in the storage unit 371. When a cancel button 604 is selected, display of the AP mode always-on setting screen 600 ends without submitting the setting content of the AP mode always-on setting. When a user sets the AP mode always-on setting to “ON” and selects the OK button 603, the AP mode start/suspend control unit 405 starts the AP mode at the timing at which the setting content is submitted or the timing at which the STA 301 is started. When a user sets the AP mode always-on setting to “OFF” and selects the OK button 603, the AP mode start/suspend control unit 405 suspends the AP mode at the timing at which the setting content is submitted if there is no wireless communication apparatus connected to the STA 301. If there is a wireless communication apparatus connected to the STA 301, the AP mode is suspended at the timing at which the wireless connection apparatus is disconnected.

FIG. 7A illustrates a screen that is displayed while the AP mode is suspended in the STA 301, while FIG. 7B illustrates a screen that is displayed while the AP mode is active in the STA 301. Specifically, for example, the screens in FIGS. 7A and 7B are displayed when a menu item indicating a status of the AP mode of the STA 301 is selected.

When the AP mode is set to “ON” on the AP mode setting screen 500, and the AP mode is suspended, the AP mode start/suspend control unit 405 displays an AP mode suspended screen 700 on the UI unit. Connection information 701 is displayed on the AP mode suspended screen 700. The connection information 701 is connection information enabling another wireless communication apparatus that operates as an STA to be connected to the STA 301, and is information that includes the SSID and the password of the access point, for example. When detecting selection of the start button 702, the AP mode start/suspend control unit 405 instructs the AP mode control unit 404 to start the AP mode. The AP mode then starts in the STA 301. Specifically, for example, transmission of a beacon that includes information regarding the SSID of the access point of the connection information 701 is started. The AP mode suspended screen 700 can also be described as a screen for accepting an instruction to start the AP mode.

When the AP mode is set to “ON” on the AP mode setting screen 500, and the AP mode is active, the AP mode start/suspend control unit 405 displays an AP mode active screen 710 on the UI unit. Connection information 711 is displayed on the AP mode active screen 710. The connection information 711 is connection information for enabling another wireless communication apparatus that operates as an STA to be connected to the STA 301, and is information that includes the SSID and the password of the access point, for example. If one or more other wireless communication apparatuses that operate as STAs are connected to the STA 301, the number of connected wireless communication apparatuses is displayed on the AP mode active screen 710. When detecting selection of an end button 712, the AP mode start/suspend control unit 405 instructs the AP mode control unit 404 to suspend the AP mode. The AP mode then ends in the STA 301. On the AP mode active screen 710, if the AP mode always-on setting is set to “ON” on the AP mode always-on setting screen 600, display control of the end button 712 may be performed such that no user operation can be made, such as the end button 712 being displayed in gray. The AP mode active screen 710 can also be described as a screen for accepting an instruction to suspend the AP mode.

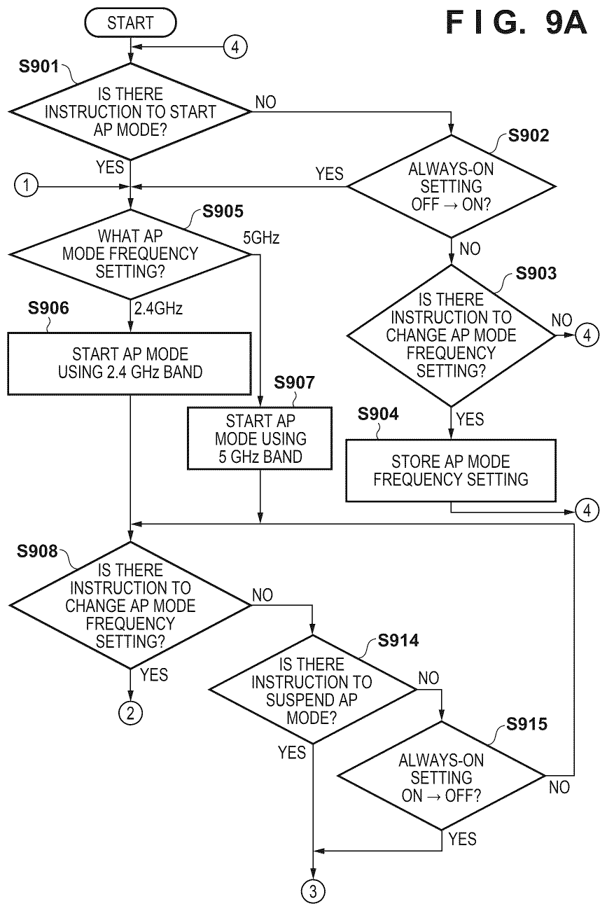

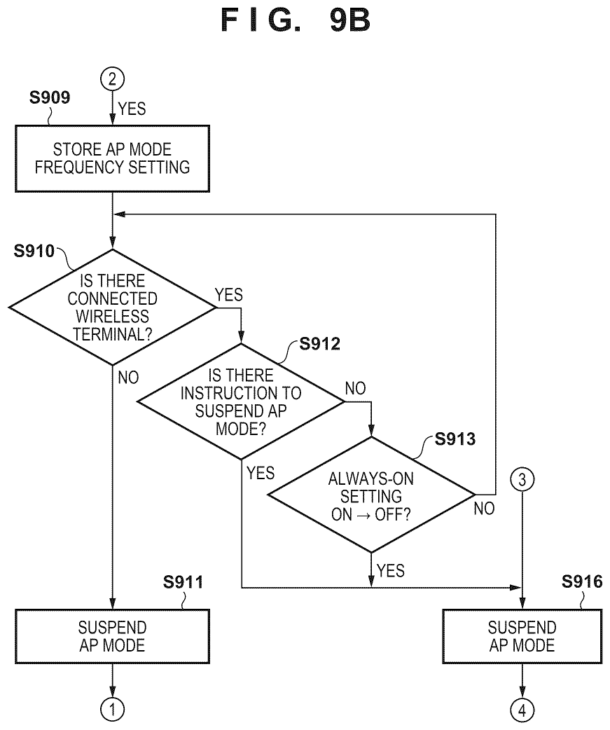

FIGS. 9A and 9B are flowcharts illustrating start and suspension of the AP mode and processing for changing the setting of the frequency band that is used for the AP mode in the STA 301. The processing in FIGS. 9A and 9B are realized by the CPU of the control unit 372 executing a program, for example. The processing in FIGS. 9A and 9B are started when the STA 301 is started. Assume that, at this time, the AP mode is set to “ON” on the AP mode setting screen 500, and the AP mode is suspended in the STA 301. In addition, assume that the AP mode always-on setting is set to “OFF” on the AP mode always-on setting screen 600.

In step S901, the control unit 372 determines whether an instruction to start the AP mode has been accepted. Specifically, for example, the control unit 372 determines whether a start button 702 of the AP mode suspended screen 700 has been selected. If it is determined that the start button 702 has not been selected, the procedure advances to step S902. If it is determined that the start button 702 has been selected, the procedure advances to step S905.

In step S902, the control unit 372 determines whether the AP mode always-on setting has been changed from “OFF” to “ON” on the AP mode always-on setting screen 600. If it is determined that the setting has not been changed from “OFF” to “ON”, in other words, the setting remains “OFF”, the procedure advances to step S903. If it is determined that the setting has been changed from “OFF” to “ON”, the procedure advances to step S905.

In step S903, the control unit 372 determines whether the setting of the frequency band has been changed on the AP mode frequency setting screen 510. If it is determined that the setting of the frequency band has not been changed, the procedure returns to step S901 and the above-described procedure is repeated. If it is determined that the setting of the frequency band has been changed, the procedure advances to step S904. In step S904, the control unit 372 stores the setting content on the AP mode frequency setting screen 510 in the storage unit 371, and the procedure then returns to step S901 and the above-described procedure is repeated. The changed setting content is not reflected on the AP mode at this timing yet.

If the setting of the frequency band has been changed in a case where the AP mode is suspended and the AP mode always-on setting is set to “OFF”, the changed setting content is stored, and an instruction to start the AP mode is waited for.

If In step S901, if it is determined that an instruction to start the AP mode has been accepted, or if in step S902 it is determined that the AP mode always-on setting has been changed to “ON” while the AP mode is suspended, the procedure advances to step S905. In step S905, the control unit 372 determines, based on the setting content on the AP mode frequency setting screen 510, whether the 2.4 GHz band or the 5 GHz band is set as the frequency band that is used for the AP mode. If it is determined that the 2.4 GHz band is set, the control unit 372 starts the AP mode using the 2.4 GHz band in step S906, and the procedure then advances to step S908. If it is determined that the 5 GHz band is set, the control unit 372 starts the AP mode using the 5 GHz band in step S907, and the procedure then advances to step S908.

In step S908, the control unit 372 determines whether the setting of the frequency band has been changed on the AP mode frequency setting screen 510. If it is determined that the setting of the frequency band has been changed, the procedure advances to step S909. If it is determined that the setting of the frequency band has not been changed, the procedure advances to step S914.

In step S909, the control unit 372 stores the setting content on the AP mode frequency setting screen 510 in the storage unit 371, and the procedure advances to step S910. Specifically, for example, if the setting of the frequency band is changed to the 5 GHz band on the AP mode frequency setting screen 510 by a user after the AP mode was started using the 2.4 GHz band, the setting content is stored in the storage unit 371 in step S909, and the procedure advances to step S910. In order to reflect the change in the setting of the frequency band on the AP mode, it is necessary to temporarily suspend and then start the AP mode, but the AP mode is not suspended yet at this timing.

In step S910, the control unit 372 determines whether there is a wireless communication apparatus (e.g., the STA 350) connected to the STA 301 in the AP mode. If it is determined that there is no wireless communication apparatus connected to the STA 301, the procedure advances to step S911. If it is determined that there is a wireless communication apparatus connected to the STA 301, the procedure advances to step S912.

In step S911, the control unit 372 temporarily suspends the AP mode, and the procedure then returns to step S905, and the AP mode is started in either step S906 or S907 as described above.

As described above, in the present embodiment, if the setting of the frequency band is changed and there is no wireless communication apparatus connected to the STA 301, the change in the setting of the frequency band can be immediately reflected on the AP mode. Here, a configuration is illustrated in which, if there is no wireless communication apparatus connected to the STA 301, the AP mode is immediately suspended in step S911, but there is no limitation thereto. For example, a configuration may be adopted in which, when a predetermined time has elapsed in a state where there is no wireless communication apparatus connected to the STA 301, the AP mode is suspended.

In step S912, the control unit 372 determines whether an instruction to suspend the AP mode has been provided. Specifically, for example, determination is performed on whether the end button 712 of the AP mode active screen 710 has been selected or whether the AP mode has been changed to “OFF” (the button 502) on the AP mode setting screen 500. If it is determined that an instruction to suspend the AP mode has been provided, the procedure advances to step S916, where the control unit 372 suspends the AP mode, and then procedure returns to step S901. If it is determined that an instruction to suspend the AP mode has not been provided, the procedure advances to step S913.

In step S913, the control unit 372 determines whether the AP mode always-on setting has been changed from “ON” to “OFF” on the AP mode always-on setting screen 600. If it is determined that the setting has been changed, the procedure advances to step S916, where the control unit 372 suspends the AP mode, and the procedure returns to step S901. If it is determined that the setting has not been changed, the procedure returns to step S910 and the above-described procedure is repeated without suspending the AP mode.

As described above, in the present embodiment, even if the setting of the frequency band has been changed, the AP mode is temporarily suspended and the AP mode is started using the changed frequency band after a wireless communication terminal connected to the STA 301 is disconnected, if there is any connected. Thus, it is possible to prevent communication with the wireless communication terminal connected to the STA 301 from being unintentionally disconnected.

Returning to FIG. 9A, in step S914, the control unit 372 determines whether an instruction to suspend the AP mode has been provided. Specifically, for example, determination is performed on whether the end button 712 of the AP mode active screen 710 has been selected or whether the AP mode has been changed to “OFF” (the button 502) on the AP mode setting screen 500. If it is determined that an instruction to suspend the AP mode has been provided, the procedure advances to step S916, where the control unit 372 suspends the AP mode, and the procedure then returns to step S901. If it is determined that an instruction to suspend the AP mode has not been provided, the procedure advances to step S915.

In step S915, the control unit 372 determines whether the AP mode always-on setting has been changed from “ON” to “OFF” on the AP mode always-on setting screen 600. If it is determined that the setting has been changed, the procedure advances to step S916, where the control unit 372 suspends the AP mode, and the procedure then returns to step S901. If it is determined that the setting has not been changed, the procedure returns to step S908 and the above-described procedure is repeated without suspending the AP mode.

In the present embodiment, in step S910, determination is performed whether there is a wireless communication apparatus connected to the STA 301, and control is performed whether to immediately suspend the AP mode based on the determination result. However, other control may be performed. For example, a configuration may be adopted in which, regardless of a state of connection to another wireless communication apparatus, steps S909 and S910 are skipped, and the procedure advances to the determination of step S912. In that case, if it is determined that, in step S913, the AP mode always-on setting has not been changed from “ON” to “OFF”, the procedure returns to step S910. That is, if the setting of the frequency band that is used for the AP mode has been changed, the AP mode is not suspended unless a clear instruction to suspend the AP mode is accepted from a user. When the procedure advances from step S912 or S913 to step S916 and the processing of step S901 and onward is repeated, the AP mode is started based on the changed setting of the frequency band.

As described above, according to the present embodiment, a changed setting of a frequency band can be reflected on the AP mode in consideration of a state of connection to another wireless communication apparatus. In addition, a frequency band can be changed at a different timing from an operation of suspending the AP mode that is intentionally performed by a user, and thus user convenience can be improved.

### Second Embodiment

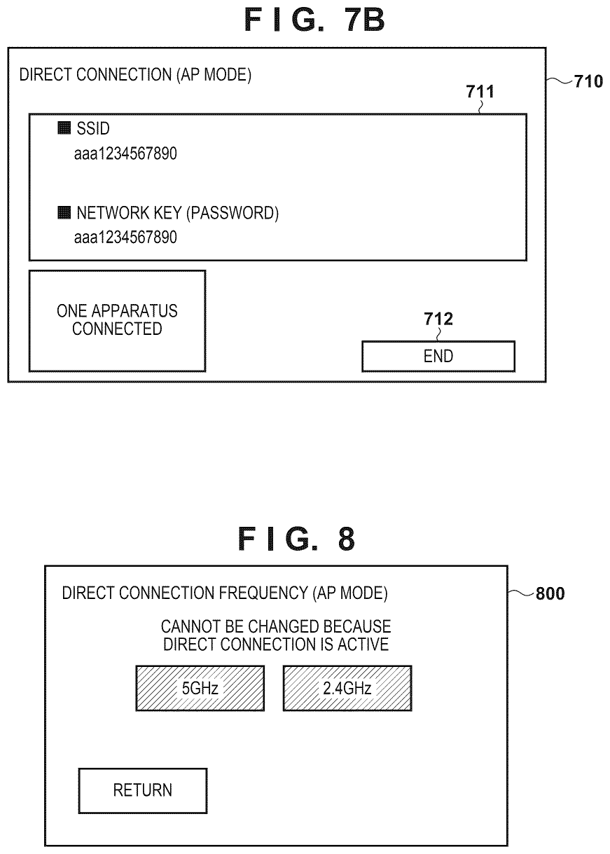

A second embodiment will now be described, focusing on differences from the first embodiment. FIG. 8 is a diagram illustrating an example of an AP mode frequency setting screen that is displayed while the AP mode is active according to the present embodiment.

In the present embodiment, when an instruction to display an AP mode frequency setting screen is provided, the connection information setting unit 401 inquires with the AP mode start/suspend control unit 405 about an AP mode activation state. If it is informed that the AP mode is active as a result of the inquiry about the activation state, an AP mode frequency setting screen 800 is displayed as illustrated in FIG. 8. That is to say, as illustrated in FIG. 8, a message indicating that the AP mode is active is displayed on the AP mode frequency setting screen 800, and display control is performed such that a user cannot change the setting of the frequency band (an instruction cannot be accepted). If it is informed that the AP mode is suspended as a result of the inquiry about the activation state, the AP mode frequency setting screen 510 in FIG. 5B is displayed.

As described above, according to the present embodiment, if the STA 301 is in the AP mode, it is possible to notify a user that the setting of the frequency band cannot be changed. By displaying the AP mode frequency setting screen 800, the procedure advances from step S908 to step S914, and it is possible to keep the setting of the frequency band from being changed while the AP mode is active.

### Third Embodiment

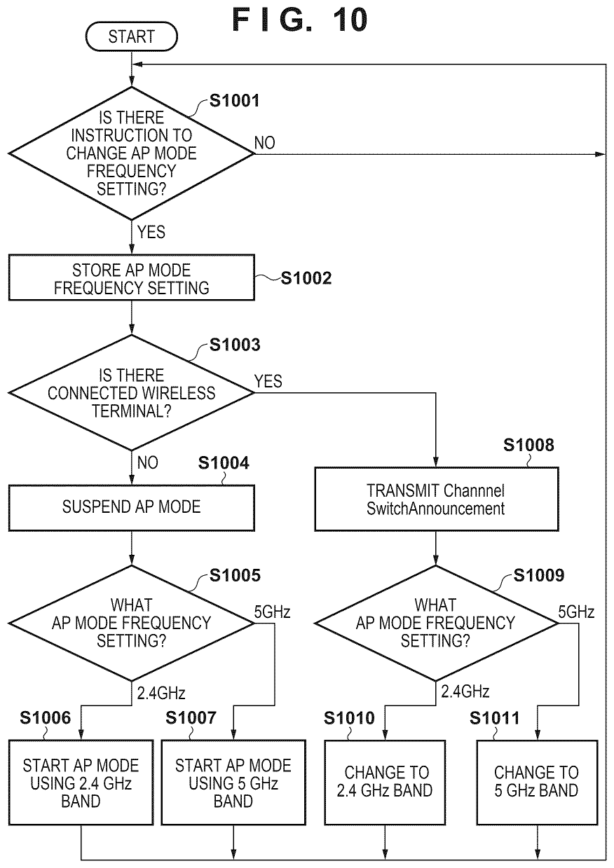

A third embodiment will now be described, focusing on differences from the first and second embodiments. FIG. 10 is a flowchart illustrating start and suspension of the AP mode and processing for changing the setting of a frequency band that is used for the AP mode in the STA 301. The processing in FIG. 10 is realized by the CPU of the control unit 372 executing a program, for example. The processing of FIG. 10 is started when the STA 301 is started. At this time, the STA 301 is in the AP mode.

In step S1001, the control unit 372 determines whether the setting of the frequency band has been changed on the AP mode frequency setting screen 510. If it is determined that the setting of the frequency band has been changed, the procedure advances to step S1002. If it is determined that the setting of the frequency band has not been changed, the procedure remains in step S1001. In step S1002, the control unit 372 stores the setting content on the AP mode frequency setting screen 510 in the storage unit 371, and the procedure advances to step S1003. The changed setting content is not reflected on the AP mode yet at this timing.

In step S1003, the control unit 372 determines whether there is a wireless communication apparatus (e.g., the STA 350) connected to the STA 301 in the AP mode. If it is determined that there is no wireless communication apparatus connected to the STA 301, the procedure advances to step S1004. If it is determined that there is a wireless communication apparatus connected to the STA 301, the procedure advances to step S1008.

In step S1004, the control unit 372 temporarily suspends the AP mode, and advances the procedure to step S1005. In step S1005, the control unit 372 determines, based on the setting content on the AP mode frequency setting screen 510, whether the 2.4 GHz band or the 5 GHz band is set as a frequency band that is used for the AP mode. If it is determined that the 2.4 GHz band is set, the control unit 372 starts the AP mode using the 2.4 GHz band in step S1006, and the procedure then returns to step S1001. If it is determined that the 5 GHz band is set, the control unit 372 starts the AP mode using the 5 GHz band in step S1007, and the procedure then returns to step S1001.

As described above, in the present embodiment, if the setting of the frequency band has been changed, and there is no wireless communication apparatus connected to the STA 301, the change in the setting of the frequency band can be immediately reflected. Here, a configuration has been illustrated in which, if there is no other wireless communication apparatus connected to the STA 301, the AP mode is immediately suspended in step S1004, but there is no limitation thereto. For example, a configuration may be adopted in which, when a predetermined time has elapsed in a state where there is no wireless communication apparatus connected to the STA 301, the AP mode is suspended.

Returning to FIG. 10, in step S1008, the control unit 372 transmits an AP mode frequency change instruction to change a frequency band that is used in communication with an STA connected to the STA 301 to the wireless communication apparatus connected to the STA 301. For example, the control unit 372 transmits a wireless frame that includes an element called a channel switch announcement and is defined in the IEEE 802.11 standard series to the wireless communication apparatus connected to the STA 301. From among the fields of this element, a “New Channel Number” field stores a value indicating a wireless frequency channel number that is to be used after the frequency band is changed. The control unit 372 stores the value in the New Channel Number field based on the setting content on the AP mode frequency setting screen 510, and transmits a wireless frame that includes the element to the wireless communication apparatus connected to the STA 301. Thus, the other wireless communication apparatus connected to the STA 301 changes the frequency channel that is used to a frequency band indicated by the value stored in the “New Channel Number”, and as a result, can continue communication with the STA 301.

In step S1009, the control unit 372 determines, based on the setting content on the AP mode frequency setting screen 510, whether the 2.4 GHz band or the 5 GHz band is set as a frequency band that is used for the AP mode. If it is determined that the 2.4 GHz band is set, the control unit 372 changes the frequency band that is used for the AP mode to the 2.4 GHz band in step S1010, and the procedure then returns to step S1001. If it is determined that the 5 GHz band is set, the control unit 372 changes the frequency band that is used for the AP mode to the 5 GHz band in step S1011, and the procedure then returns to step S1001. That is, in steps S1010 and S1011, the AP mode is not suspended when changing the frequency band, and thus it is possible to continue communication with the wireless communication apparatus connected to the STA 301.

As described above, according to the present embodiment, a changed setting of a frequency band can be reflected on the AP mode in consideration of a connection state of another wireless communication apparatus. In addition, a wireless communication apparatus connected to an STA serving as an access point is notified of the change in the frequency band, and the frequency band that is used for the AP mode is then changed. With such a configuration, it is possible to change the frequency band that is used for the AP mode while maintaining communication with the wireless communication apparatus connected to the STA operating as an access point, thus improving user convenience. An example of an operation of changing the frequency band in the AP mode has been illustrated above, but a similar operation may also be performed in the WFD mode. Specifically, for example, when an instruction to change the frequency band is accepted from the user while operating as a GO in the WFD mode, the frequency band is not changed at the timing at which the instruction is accepted. When the WFD mode is started again, the change in the frequency band is reflected.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088279, filed May 30, 2024, which is hereby incorporated by reference herein in its entirety.

What is claimed is:

1. An information processing apparatus comprising:
at least one memory and at least one processor that function to:
perform wireless communication with a partner apparatus without using an external access point by the information processing apparatus operating as an access point;
set a frequency band that is used when the information processing apparatus operates as the access point; and
perform control such that, when the setting of the frequency band is changed while the information processing apparatus is operating as the access point, the frequency band is not changed before the information processing apparatus stops operating as the access point, and the information processing apparatus operates based on the changed setting of the frequency band when newly starting operating as the access point after stopping operating as the access point.

2. The information processing apparatus according to claim 1,
wherein, the least one memory and at least one processor further function to perform control such that the information processing apparatus operates using a frequency band set before the setting of the frequency band was changed, until the information processing apparatus stops operating as the access point.

3. The information processing apparatus according to claim 1,
wherein the information processing apparatus stops operating as the access point based on a state where there is no partner apparatus connected to the information processing apparatus that operates as the access point.

4. The information processing apparatus according to claim 3,
wherein the information processing apparatus stops operating as the access point without accepting a user instruction.

5. The information processing apparatus according to claim 1,
wherein the information processing apparatus stops operating as the access point based on a state where there is a partner apparatus connected to the information processing apparatus that operates as the access point.

6. The information processing apparatus according to claim 5,
wherein the information processing apparatus stops operating as the access point based on acceptance of a user instruction.

7. The information processing apparatus according to claim 6,
wherein the user instruction is an instruction to de-activate an operation as the access point.

8. The information processing apparatus according to claim 6,
wherein the user instruction is an instruction to de-activate an always-on operation of the access point.

9. The information processing apparatus according to claim 6,
wherein, when there is a partner apparatus connected to the information processing apparatus that operates as the access point, the at least one memory and at least one processor further perform control to not stop the information processing apparatus from operating as the access point unless the user instruction is accepted.

10. The information processing apparatus according to claim 1,
further comprising a user interface screen.

11. The information processing apparatus according to claim 10,
wherein, when the setting of the frequency band is changed, information indicating that the information processing apparatus is operating as an access point is displayed on the user interface screen.

12. The information processing apparatus according to claim 11,
wherein, information indicating that the change in the setting of the frequency band will be reflected on an operation when the information processing apparatus newly starts operating as an access point after stopping operating as the access point is displayed on the user interface screen.

13. The information processing apparatus according to claim 10,
wherein the at least one memory and the at least one processor further function to control the user interface screen to not allow the setting of the frequency band to be changed when an instruction instructing that the information processing apparatus start operating as the access point is accepted.

14. The information processing apparatus according to claim 1,
wherein the at least one memory and the at least one processor further function to:
transmit, if there is a partner apparatus connected to the information processing apparatus that operates as the access point, information regarding a frequency band whose setting has been changed to the partner apparatus, and
perform control such that, after the information regarding the frequency band is transmitted, the information processing apparatus operates based on the changed setting of the frequency band without stopping operating as the access point.

15. The information processing apparatus according to claim 14,
wherein the information regarding the frequency band whose setting has been changed is included in a channel switch announcement of a wireless frame defined in IEEE 802.11 standard series, and
wherein the wireless frame is transmitted.

16. The information processing apparatus according to claim 14,
wherein, when control is performed such that, after the information regarding the frequency band is transmitted, the information processing apparatus operates based on the changed setting of the frequency band without stopping operating as the access point, control perform control such that, when the setting of the frequency band is changed while the information processing apparatus is operating as the access point, the frequency band is not changed before the information processing apparatus stops operating as the access point, and the information processing apparatus operates based on the changed setting of the frequency band when newly starting operating as the access point after stopping operating as the access point is not performed.

17. The information processing apparatus according to claim 1,
wherein frequency band is set as a 2.4 GHz band or a 5 GHz band.

18. The information processing apparatus according to claim 1,
wherein the information processing apparatus is an image forming apparatus that includes an image forming unit configured to form an image on a printing medium using a printing agent.

19. A method executed by information processing apparatus, the method comprising:
performing wireless communication with a partner apparatus without using an external access point by the information processing apparatus operating as an access point;
setting a frequency band that is used when the information processing apparatus operates as the access point; and
performing control such that, when the setting of the frequency band is changed while the information processing apparatus is operating as the access point, the frequency band is not changed before the information processing apparatus stops operating as the access point, and the information processing apparatus operates based on the changed setting of the frequency band when newly starting operating as an access point after stopping operating as the access point.

20. A non-transitory computer-readable storage medium that stores one or more programs including instructions, which when executed by at least one memory and at least one processor of an information processing apparatus, cause the information processing apparatus to:
perform wireless communication with a partner apparatus without using an external access point by the information processing apparatus operating as an access point;
set a frequency band that is used when the information processing apparatus operates as the access point; and
perform control such that, when the setting of the frequency band is changed while the information processing apparatus is operating as the access point, the frequency band is not changed before the information processing apparatus stops operating as the access point, and the information processing apparatus operates based on the changed setting of the frequency band when newly starting operating as an access point after stopping operating as the access point.
